(19) United States
(12) Patent Application Publication
(10) Pub. No.: US 2015/0197634 A1
(43) Pub. Date: Jul. 16, 2015

(54) THERMALLY STABLE TRANSPARENT COMPOSITE MATERIALS

(71) Applicant: U.S. Army Research Laboratory ATTN: RDRL-LOC-I, Adelphi, MD (US)

(72) Inventors: DANIEL J. O'BRIEN, Hydes, MD (US); Eric D. Wetzel, Baltimore, MD (US)

(73) Assignee: United States Government as Represented by the Secretary of the Army

(21) Appl. No.: 14/499,346

(22) Filed: Sep. 29, 2014

Related U.S. Application Data
(60) Provisional application No. 61/889,595, filed on Oct. 11, 2013.

(51) Int. Cl. C08L 77/00; C08L 23/12; C08L 33/00; C08L 63/00

(52) U.S. Cl. CPC C08L 77/00; C08L 63/00; C08L 23/12; C08L 33/00; C08L 2201/10; C08L 2205/03; C08L 2205/16

(57) ABSTRACT

A composite material having a transparent reinforcement constituent encased in a transparent matrix constituent is described and illustrated herein. The reinforcement constituent and matrix constituent are selected so that a difference of the refractive index between the two constituents is less than 0.003 for visible light and across a temperature range of at least 0 degrees centigrade to 50 degrees centigrade.

### CROSS-REFERENCE TO RELATED APPLICATIONS

This application claims priority of U.S. Provisional Application No. 61/889,595 filed Oct. 11, 2013, the contents of which are incorporated herein by reference.

### GOVERNMENT INTEREST

The invention described herein may be manufactured, used, and licensed by or for the United States Government.

### BACKGROUND OF THE INVENTION

I. Field of the Invention

The present invention relates generally to composite materials and, more particularly, to a transparent composite material.

II. Description of Related Art

Continuous fiber reinforced polymer matrix composite materials have emerged as a mass efficient protection material for a range of ballistic and blast applications. Compared to monolithic materials, composite materials provide a unique combination of high fracture toughness and low density.

This reinforcement in properties is due, in large part, to the use of high performance fibers, such as S-glass, carbon, and aramid. Composite materials also offer energy absorbing damage modes, such as delamination and fiber pullout that are not present in monolithic materials. In addition, the mechanical properties of composites can be tailored to a given application through selection and control of reinforcement type, orientation, and volume fraction.

There are many specialized applications, however, in which the protection material in the ballistic and blast applications must be transparent. Such applications include, for example, visors, windshields, optical sensors, etc. Composites are not suitable for these applications since they are not typically transparent. Instead, conventional transparent armors are constructed of monolithic or layered plates containing transparent polymers, glasses, and ceramics. Furthermore, while a fiber reinforced transparent composite could provide enhancements in the mechanical properties and design flexibility relative to the monolithic or laminated materials; such traditional composite materials are rarely transparent. Rather, most conventional composite constituents, such as carbon fibers and aramid fibers, are highly absorbent of visible light or scatter visible light over much of the visible light spectrum and, therefore, cannot be used directly to create transparent composites. Other materials, such as amorphous or nanocrystalline polymers and glass fibers, can be visually transparent but have a limited physical transparency due to the presence of voids and other impurities that absorb and/or scatter visible light. Finally, even when two perfectly transparent materials are combined into a composite, if their spectral refractive indices are not identical, then refraction, reflection and scattering effects lead to an unacceptable loss in visible clarity.

In order to create transparent composites, two general approaches have been previously taken. One technique is to reduce the reinforcement size below the critical scattering length, typically less than about 200 nanometers, for visual transparency. Such transparent composites can be manufactured by infiltrating monomers into nanoporous silica foams and polymerizing in situ, or electrospun polymer fiber mats can be infiltrated with a polymer to obtain transparent materials. However, while these approaches typically yield materials with high transparency, they do not have the mechanical properties necessary for many ballistics and blast applications because the reinforcement is either discontinuous or of low volume fraction and/or randomly oriented.

A second approach to create transparent composites is to engineer the matrix and reinforcement phases to have matched refractive indices. This approach is attractive since common materials, such as glass fibers and epoxy resins, have similar refractive indices. However, a serious limitation of the index matching approach arises from the temperature dependence of the refractive index known as the thermo-optic coefficient, dn/dT, where n and T are the refractive index and temperature, respectively. Since the thermo-optic behavior is driven mostly by density, materials with higher coefficients of thermal expansion tend to have greater thermo-optic coefficients. As a result, polymers typically have a thermo-optic coefficient of approximately 0.0001/degree centigrade. Since transparency requires that the constituent indices be matched to approximately 0.001, the polymer's thermo-optic coefficient leads to a significant refractive index mismatch after a relatively minor, e.g. 10 degrees C., temperature change. As a result, composite transmissivity tends to be highly temperature dependent with high transparency only possible within a narrow window of temperature. Since military equipment must be capable of satisfactory operation over a wide temperature range, such loss in transparency is unacceptable.

In order to reduce the requirements of index matching and increase the useful temperature window of an index matched composite, ribbon reinforcements with prismatic cross sectional shape, e.g. square or rectangular, have been previously used. Due to its flat surface, such reinforcement does not refract light like circular fibers, thus preserving optical properties as the light propagates through the medium. However, ribbon reinforcement reduces, but does not eliminate, the temperature dependent transmission.

### SUMMARY OF THE PRESENT INVENTION

The present invention provides a composite material which overcomes the above mentioned disadvantages of the previously known materials used for transparent devices in projectile and blast applications.

In brief, the present invention includes a transparent reinforcement constituent which is encased in a transparent matrix constituent, both of which are preferably constructed of a polymer. The reinforcement constituent and the matrix constituent are selected so that a difference of the refractive index between the reinforcement constituent and the matrix constituent is less than 0.003 for visible light and across a temperature range of at least 0 degrees C. to 50 degrees C.

Preferably, the reinforcement constituent includes elongated monomer filaments, such as nylon filaments, which are embedded in a matrix. The filaments preferably are aligned with each other, although nonaligned or woven reinforcement filaments may alternatively be used.

Since the reinforcement constituent as well as the matrix constituent has a refractive index difference of less than 0.003 for visible light and across a temperature range of at least 0 degrees C. to 50 degrees C., the composite material maintains its transparency throughout the range of visible light as well as the temperature range of 0-50 degrees centigrade.

In yet another embodiment of the present invention, a third, optional constituent surrounds the reinforcement phase. The material selected to wrap the reinforcement filaments, preferably has a refractive index between the reinforcement constituents and the matrix constituents. In this fashion, any mismatch between the wrapping material and the reinforcement constituents as well as the matrix constituents is reduced, thus, enhancing the transparency of the resulting composite material.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a sectional perspective view illustrating a preferred embodiment of the invention;

FIG. 2 is a view similar to FIG. 1, but illustrating a modification thereof;

FIG. 3 is a graph illustrating relative transmission versus temperature for a few examples illustrated examples;

FIG. 4 is a photograph of an example including nylon ribbons (cross-ply) embedded in epoxy matrix;

FIG. 5 is a is a photograph of an example including polypropylene ribbons (cross-ply) embedded in acrylic matrix; and

FIG. 6 is a a photograph of an example including polypropylene ribbons unidirectionally embedded in acrylic matrix.

### DETAILED DESCRIPTION OF PREFERRED EMBODIMENTS OF THE PRESENT INVENTION

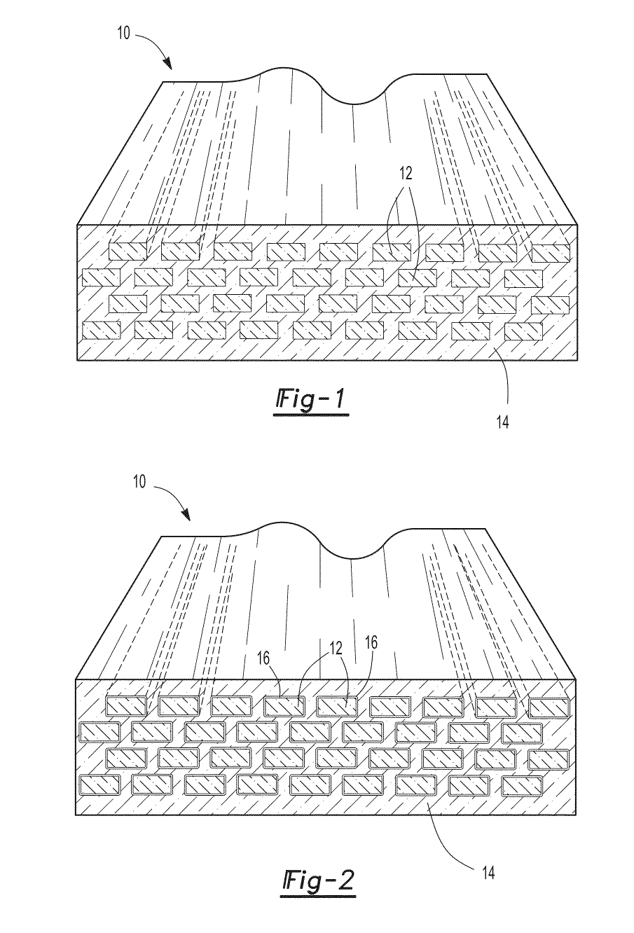

With reference first to FIG. 1, an example of a composite material 10 according to the present invention is shown. The composite material 10 includes both a reinforcement constituent 12 which is encased within a matrix constituent 14. Preferably, both the reinforcement constituent 12 as well as the matrix constituent 14 are made of a polymer although, alternatively, ceramics, glass, or even an open-cell foam may be used. Suggested matrix polymeric materials include, but are not limited to, epoxies, polyesters such as polymethyl methacrylate (PMMA) and polycarbonate (PC), and polyamides or nylons.

The reinforcement fibers 12 are illustrated in FIG. 1 as aligned with each other in a set direction. However, such alignment of the reinforcement constituent 12 is not required. Instead, the reinforcement constituent 12 may extend, if desired, in random directions or be woven into a 2- or 3-dimensional fabric.

Both the reinforcement constituent 12 as well as the matrix constituent 14 is selected so that the difference between the refractive index for the reinforcement constituent and the matrix constituent is less than 0.003 for visible light and across a temperature range of at least 0 degrees centigrade to 50 degrees centigrade. Preferably, the refractive difference remains less than 0.003 over an even wider range of −40 degrees centigrade to 140 degrees centigrade.

The constituents are preferably made of an amorphous material. However, a crystalline material may alternatively be used for one or both of the constituents provided the crystals are optically isotropic or so small in their dimension that they do not scatter light.

The cross sectional dimension of the reinforcement constituent 12 is preferably rectangular, square, or elliptical having a dimension that is less than 1 millimeter×5 millimeters. However, in order to enhance the transparency of the composite material 10, the constituent material preferably has a cross sectional size of 500 micrometers×50 micrometers or less.

Since the reinforcement constituent 12 and the matrix constituent 14 are selected so that the difference between their refractive index is less than 0.003 for visible light across the temperature range of at least 0 degrees centigrade to 50 degrees centigrade, and since both the transparent reinforcement constituent and matrix constituent are transparent to visible light, the resulting composite material 10 remains highly transmissive to visible light. Furthermore, the percent of light transmission through the composite material increases as the difference between the refractive index of the reinforcing material 12 and the reinforcing matrix 14 becomes smaller.

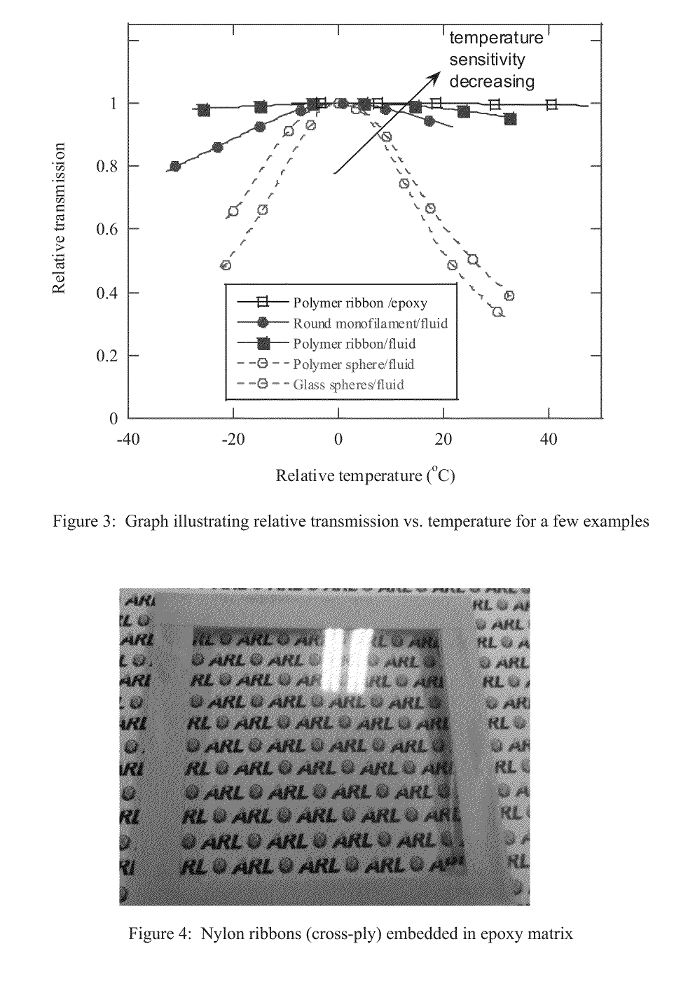

To demonstrate the temperature insensitivity in optical transmission of a polymer matrix reinforced with polymer ribbons compared to other composite materials, temperature-dependent transmission experiments were performed on a variety of composites using a UV/Visible spectrometer (model Lambda 950, Perkin-Elmer, Waltham, Mass.) fitted with a heated sample holder. The matrices included either an epoxy polymer or immersion fluids, and reinforcements included nylon monofilaments with rectangular or round cross sections as well as PMMA polymer spheres or glass spheres. Immersion fluids were used as model matrices for thermo-optic measurements because they permit easy tailoring of refractive index. FIG. 3 shows the relative transmission of each of the composites across a range of temperatures. Considering the glass and PMMA spheres, the plot shows a decrease in temperature sensitivity from glass to PMMA, presumably because dn/dT of the PMMA spheres is closer to the matrix than the dn/dT of the glass spheres. The plot also shows the affect of reinforcement shape with temperature sensitivity decreasing between the spheres to filaments with round cross-section to those with rectangular cross section. Finally, a composite corresponding to the present invention, the rectangular polymer filament in epoxy shows the very little temperature dependence, because the dn/dT of the matrix and reinforcement are well matched.

One example of the invention has been made from nylon polymer ribbons embedded in an epoxy polymer matrix. A photograph of this example is presented in FIG. 4 and illustrates the improved transmission, haze, and clarity of this example. This example has four layers of ribbon in a cross-ply configuration with two layers oriented in the 0° direction (parallel to the specimen's bottom edge) and two layers in the 90° direction. The thickness is approximately 0.9 mm. The transmission, haze, and clarity of the specimen, measured with a haze meter (Haze-gard plus, Byk-Gardner Inc., Geretsried, Germany) are 94%, 6.0%, and 89%, respectively.

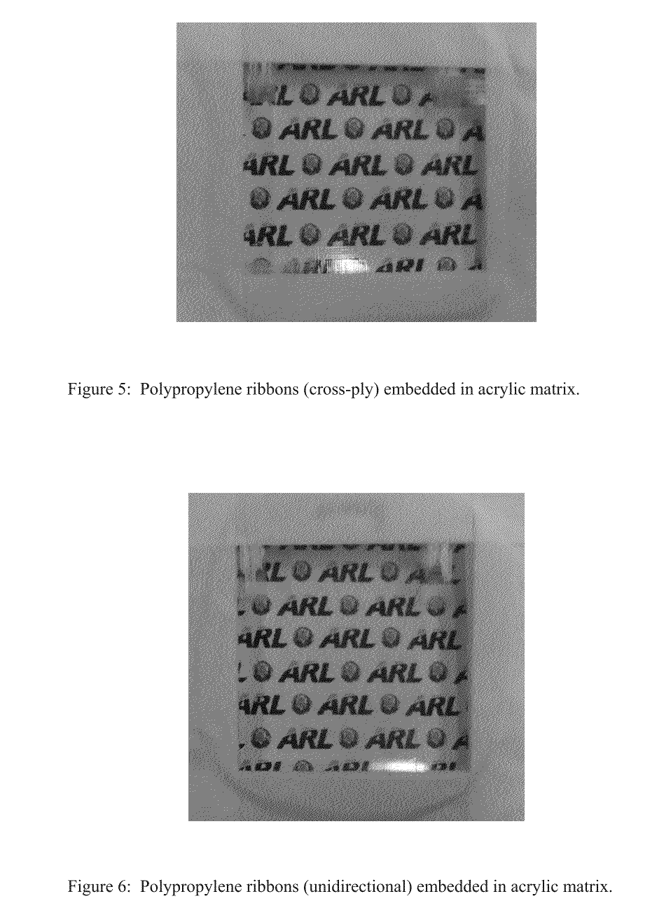

A second example of the invention was made from polypropylene polymer ribbons embedded in an acrylic polymer matrix. A photograph of this example is presented in FIG. 5 and illustrates the improved transmission, haze, and clarity of this example. This example has four layers of ribbon in a cross-ply configuration with two layers oriented in the 0° direction and two layers in the 90°. To aid manufacture, this sample was manufactured by winding ribbons around a glass slide (1.5 mm thick). As such, two of the ribbon layers are on top of the slide and two are below the slide. The total thickness is 2.4 mm. The transmission, haze, and clarity of the specimen are 93%, 8.5%, and 83%, respectively.

A third example of the invention was also made from polypropylene polymer ribbons embedded in an acrylic polymer matrix. A photograph of this example is presented in FIG. 6 and illustrates the improved transmission, haze, and clarity of this example. This example has two layers of ribbon oriented in the 0° direction (unidirectional). To aid manufacture, this sample was manufactured by winding ribbons around a glass slide (1.5 mm thick). As such, one of the ribbon layers is on top of the slide and one is below the slide. The total thickness is 1.9 mm. The transmission, haze, and clarity of the specimen are 91%, 6.6%, and 92%, respectively.

With reference now to FIG. 2, a modification of the invention is shown in which the reinforcement constituent 12 is coated with an interphase layer 16, such as a monolithic polymer layer or nanoparticles that do not scatter light. The interphase layer may be of the same material as the reinforcing constituent 12 or of other materials. If made of other materials, the interphase layer 16 preferably has a refractive index between the refractive index of the reinforcement constituent 12 and the matrix constituent 14. In this fashion, the transparency of the overall composite material is enhanced.

Many reinforcement constituents in fiber form exhibit different refractive indices in different directions. In order to eliminate, or at least greatly reduce, the multiple refractive indices, a dopant molecule with a birefringence of opposite sign to the host filament material is mixed into the host filament prior to forming the host filament material into fibers. Upon drawing the fiber during manufacture, the birefringent compound aligns with the host filament material so that the opposing birefringent signs and the relative concentrations of the host filament material and dopant render the filament optically isotropic. The dopant material may be a nanoparticle.

From the foregoing, it can be seen that the present invention provides a composite material that is transparent over not only the visible range, but also a wide temperature range. Having described my invention, however, many modifications thereto will become apparent to those skilled in the art to which it pertains without deviation from the spirit of the invention as defined by the scope of the appended claims.

I claim:

1. A composite material comprising:
a transparent reinforcement constituent encased in a transparent matrix constituent, said reinforcement constituent and said matrix constituent selected so that a difference of the refractive index between said reinforcement constituent and said matrix constituent is less than 0.003 for visible light and across a temperature range of at least 0 degree C. and 50 degree C.

2. The composite material as defined in claim 1 wherein at least one of said constituents comprises an amorphous material.

3. The composite material as defined in claim 2 wherein both constituents comprise an amorphous material.

4. The composite material as defined in claim 1 wherein at least one constituent comprises a polymer.

5. The composite material as defined in claim 4 wherein both constituents comprise a polymer.

6. The composite material as defined in claim 1 wherein said visible light has a wavelength substantially between 400 nanometers and 700 nanometers.

7. The composite material as defined in claim 1 wherein said reinforcement constituent comprises elongated filaments.

8. The composite material as defined in claim 7 wherein, during manufacture, said filaments are doped with a material which renders the filaments optically isotropic.

9. The composite material as defined in claim 7 wherein said filament is rectangular, square or elliptical in cross sectional shape.

10. The composite material as defined in claim 7 wherein said fibers have a cross section of less than 500 microns by 50 microns in cross section.

11. The composite material as defined in claim 7 wherein said fibers have a cross section of less than 5 mm by 1 mm in cross section.

12. The composite material as defined in claim 7 wherein said filaments are aligned in substantially the same direction.

13. The composite material as defined in claim 7 wherein said matrix constituent comprises an epoxy, a polyester, or a polyamide.

14. The composite material as defined in claim 1 and comprising an interphase constituent covering at least a portion of said reinforcement constituent.

15. The composite material as defined in claim 14 wherein said interphase constituent has a refractive index between the refractive index for said reinforcement constituent and said matrix constituent for visible light and across a temperature range of at least 0 degree C. and 50 degree C.

16. The composite material as defined in claim 14 wherein said interphase constituent is less than 100 microns in thickness.

17. The composite material as defined in claim 1 wherein at least one constituent comprises a ceramic.

18. The composite material as defined in claim 1 wherein at least one of said constituents comprises polycarbonate.

19. The composite material as defined in claim 1 wherein said reinforcement constituent is doped with a birefringence compound which renders the reinforcement constituent optically isotropic.

20. The device of claim 1 in which one or more constituents are made of a crystalline material in which the crystals are optically isotropic or so small in their dimensions that they do not scatter light.
